(19) United States
(12) Patent Application Publication
(10) Pub. No.: US 2026/0197102 A1
(43) Pub. Date: Jul. 9, 2026

(54) SIDELINK COMMUNICATION

(71) Applicant: Nokia Technologies Oy, Espoo (FI)

(72) Inventors: György Tamás WOLFNER, Budapest (HU); Vinh VAN PHAN, Oulu (FI); Ling YU, Kauniainen (FI); Faranaz SABOURI-SICHANI, Aalborg (DK); Torsten WILDSCHEK, Gloucestershire (GB); Jakob Lindbjerg BUTHLER, Aalborg (DK)

(21) Appl. No.: 19/128,092

(22) PCT Filed: Sep. 19, 2023
(86) PCT No.: PCT/EP2023/075730

§ 371 Date: May 7, 2025

(30) Foreign Application Priority Data
Nov. 7, 2022 (FI) 20226003

(51) Int. Cl. H04B 17/318; H04W 52/36

(52) U.S. Cl. CPC H04B 17/318; H04W 52/367

(57) ABSTRACT

According to an example aspect of the present invention, there is provided a user equipment comprising at least one processing core and at least one memory storing instructions that, when executed by the at least one processing core, cause the user equipment at least to measure a received signal strength of a unicast transmission received in the user equipment from another user equipment, UE, over a direct UE-to-UE radio link, obtain at least one power adjustment parameter concerning the other UE, and include in a report to a base station node, or a further user equipment, UE, either: the measured received signal strength as modified with the at least one power adjustment parameter, or both the measured received signal strength and the at least one power adjustment parameter.

### FIELD

The present disclosure relates to wireless communication in the context of a cellular communication system.

### BACKGROUND

In the context of a cellular communication system comprising plural base stations, user equipments, UEs, of the cellular communication system may be configured to communicate not only using radio links with base stations, but also with direct UE-to-UE radio links. Such direct UE-to-UE radio links involve a first UE transmitting energy in the form of electromagnetic waves, which waves are received by receiver of a second UE, that is, the direct UE-to-UE radio link does not traverse a base station.

Different terminology may be applied to direct UE-to-UE communication without departing from the basic premise described above. For example such a communication mode has been referred to as sidelink, device-to-device, D2D, and proximity-based services, ProSe. Direct UE-to-UE radio link communication enables useful use cases, such as a UE using another UE as a relay to access the cellular communication system from a location which is outside the coverage area of the cellular communication system.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided a user equipment comprising at least one processing core and at least one memory storing instructions that, when executed by the at least one processing core, cause the user equipment at least to measure a received signal strength of a unicast transmission received in the user equipment from another user equipment, UE, over a direct UE-to-UE radio link, obtain at least one power adjustment parameter concerning the other UE, and include in a report to a base station node, or a further user equipment, UE, either: the measured received signal strength as modified with the at least one power adjustment parameter, or both the measured received signal strength and the at least one power adjustment parameter.

According to a second aspect of the present disclosure, there is provided a method comprising measuring, in a user equipment, a received signal strength of a unicast transmission received in the user equipment from another user equipment, UE, over a direct UE-to-UE radio link, obtaining at least one power adjustment parameter concerning the other UE, and including in a report to a base station node, or to a further UE, either: the measured received signal strength as modified with the at least one power adjustment parameter, or both the at least one measured received signal strength and the power adjustment parameter.

According to a third aspect of the present disclosure, there is provided a user equipment comprising means for measuring, in the user equipment, a received signal strength of a unicast transmission received in the user equipment from another user equipment, UE, over a direct UE-to-UE radio link, means for obtaining at least one power adjustment parameter concerning the other UE, and means for including in a report to a base station node or to a further UE either: the measured received signal strength as modified with the at least one power adjustment parameter, or both the measured received signal strength and the at least one power adjustment parameter.

According to a fourth aspect of the present disclosure, there is provided a non-transitory computer readable medium having stored thereon a set of computer readable instructions that, when executed by at least one processor, cause a user equipment to at least measure a received signal strength of a unicast transmission received in the user equipment from another user equipment, UE, over a direct UE-to-UE radio link, obtain at least one power adjustment parameter concerning the other UE, and include in a report to a base station node or to a further UE either: the measured received signal strength as modified with the at least one power adjustment parameter, or both the measured received signal strength and the at least one power adjustment parameter.

### BRIEF DESCRIPTION OF THE DRAWINGS

FIG. 1 illustrates an example system in accordance with at least some embodiments;

FIG. 2 illustrates an example system in accordance with at least some embodiments;

FIG. 3 illustrates an example apparatus capable of supporting at least some embodiments;

FIG. 4 illustrates signalling in accordance with at least some embodiments, and

FIG. 5 is a flow graph of a method in accordance with at least some embodiments.

### EMBODIMENTS

Processes are described herein which facilitate procedures in direct UE-to-UE communication. In particular, reporting candidate relay UEs toward the network is enhanced by adjusting measured received signal strength powers of signals unicasted from the candidate relay UEs, to account for power control in a direct UE-to-UE link. The network is then enabled to make better-informed decisions on which candidate relay UE to select as a relay UE, or as a new relay UE in case relaying is already being used. Examples of how to adjust the measured received signal powers are described herein below.

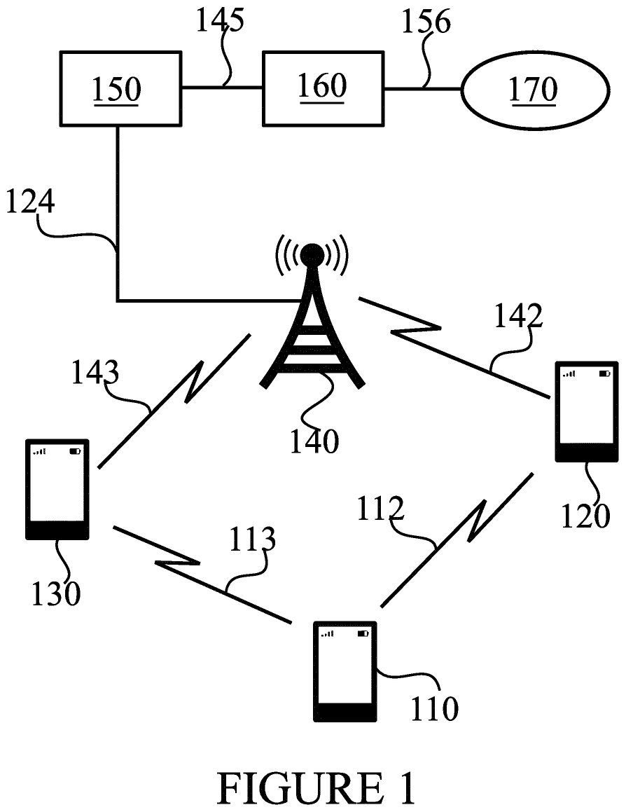

FIG. 1 illustrates an example system in accordance with at least some embodiments. The example of FIG. 1 is a cellular system, but the herein disclosed methods are not limited to being applied in a cellular context. FIG. 1 illustrates a base station 140, which is configured to operate in accordance with a cellular communication standard, such as long term evolution, LTE, or fifth generation, 5G, also known as New Radio, NR, both as specified by the 3rd generation partnership project, 3GPP. Where a non-cellular system is used, an access node, such as access point, corresponding to base station 140 may be configured in accordance with a non-cellular communication standard such as wireless local area network, WLAN, or worldwide interoperability for microwave access, WiMAX, for example.

Base station 140 is coupled with a core network node 150 via link 124, which may comprise a wire-line connection, for example. Core network node 150 may comprise a mobility management entity, MME, a serving gateway, S-GW, or an access and mobility management function, AMF, for example. The core network may comprise a gateway 160, connected to core network node 150 via link 145. Gateway 160 enables communication with further networks 170, via inter-network link 156. In non-cellular systems, core network node 150 and gateway 160 may be absent, with the access node corresponding to base station 140 being directly connected to further networks, for example. Link 145 and inter-network link 156 may be wire-line links, for example.

Further, in the illustrated example situation, base station 130 is in wireless radio communication with user equipments, UEs 120 and 130. Each UE may comprise, for example, a smartphone, feature phone, tablet or laptop computer, Internet-of-Things, IoT, node, smart wearable or a connected car connectivity module, for example. Naturally, separate UEs need not be of the same type. Wireless communication link 142 connects base station 140 with UE 120, and wireless communication link 143 connects base station 140 with UE 130. Wireless communication links 142, 143 may each have an uplink for conveying information from the respective UE to base station 140, and a downlink for conveying information from base station 140 to the respective UE.

Additionally, the system of FIG. 1 has direct UE-to-UE links 112 and 113, enabling UE 110 to communicate directly with UEs 120 and 130, respectively. UE 120, for example, may act as relay for UE 110, such that UE 110 may access e.g. information from further network 170, for example by browsing Web sites. UE 110 needs to be in range of direct UE-to-UE communication, to enable direct UE-to-UE link 112 to function. The communication range of direct UE-to-UE links, such as links 112 and 113, may be shorter than the range of wireless communication links UEs have with base stations. The longer the distance between UE 110 and the relay UE 120, the higher is the consumption of power in UE 120. As UEs are often battery-powered, their power resources are fairly limited.

When initiating a relaying session toward a network, or in case the relay UE needs to be changed, a UE needs to be selected to act as the relay. For example, the existing relay may be moving out of range of the direct UE-to-UE link, wherefore the direct UE-to-UE communication session will be interrupted unless the relay is changed. Alternatively, battery power in the relay UE may decline to such an extent, that the relay UE informs the network and/or the UE it is serving that it is unwilling to continue in its role as relay.

To enable the network to select a new relay UE from among a set of possible UEs, the UE that is to use the relay, in the example of FIG. 1 this being UE 110, may measure in its receiver signal strengths of direct UE-to-UE signals transmitted by UEs in the set and report identities of UEs in the set and received signal strengths from the respective UEs in the set to the network. The UE which uses the relay to access the network may be referred to as the remote UE.

Direct UE-to-UE signals may be transmitted as broadcasted discovery messages, or they may be unicasted to a specific UE as part of an ongoing direct UE-to-UE connection between these UEs, or as a unicasted discovery message in response to a discovery solicitation from the specific UE. Received signal strength measurements may be conducted on both types of signals. In 3GPP networks these are referred to as sidelink discovery reference signal received power, SD-RSRP, and sidelink reference signal received power, SL-RSRP, respectively.

As broadcasted signals are not addressed to a particular recipient, they may be transmitted at a constant power each time. In particular, the constant power used may be the maximum direct UE-to-UE power the transmitting UE is able, or allowed, to use. It is noted that there may be different power classes for transmitting UEs with differing maximum allowed direct UE-to-UE transmit powers. As the broadcasted messages may be used in discovery, using the maximum power makes sense as the strong transmit power best facilitates reception of the broadcasted message by UEs even further away.

On the other hand, unicasted signals may be part of an ongoing connection between two UEs, such that the signals are meant only for the one intended recipient. Using the maximum power for these connections would be inefficient as too much power is used, and a power control mechanism may be employed instead, such that a required quality of service is achieved on the direct UE-to-UE link, and no power is used in excess of the power needed for this, possibly allowing for using slightly more to obtain reliability against fading.

As a result of the foregoing, reference signal received power, RSRP, measurements on broadcasted and unicasted direct UE-to-UE transmissions are difficult to compare to each other. Assuming the same pathloss to two transmitting UEs, one of which broadcasts and the other unicasts, RSRP measurements on signals from these UEs may result in widely diverging results. For example, the RSRP measurement result on the signal from the broadcasting UE may be the maximum transmit power, attenuated by the pathloss. At the same time, the RSRP measurement result on the signal from the unicasting UE may be, due to the functioning of the power control, simply the target received power of the power control mechanism, which may depend on the type of service being run. In other words, the RSRP value of the signal from the unicasting UE does not necessarily in itself disclose anything of the pathloss between the UEs. Thus, measuring the RSRP of such UEs does not produce much useful information for e.g. relay UE selection.

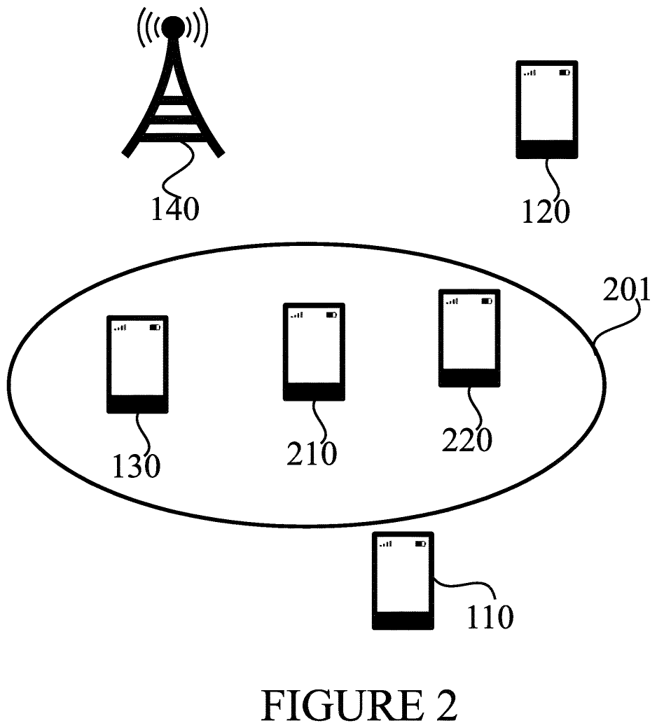

FIG. 2 illustrates an example system in accordance with at least some embodiments. Like numbering denotes like structure as in FIG. 1. In the situation of FIG. 2, UE 110 has a relay session with the network via UE 120 acting as the relay. UEs 110 and 120 are connected by a direct UE-to-UE link.

For one reason or another, a new relay needs to be selected to replace UE 120, e.g. UE 120 may be moving further from UE 110, making the direct UE-to-UE link between these devices more difficult and energy-intensive to maintain. A set 201 of candidate UEs comprises UEs 130, 210 and 220. In general, the candidate UEs are other UEs than UE 110. UE 110 measures RSRP values concerning signals from each one of these. Of these UE 130 broadcasts its signal to UE 110 via a direct UE-to-UE link, and UEs 210 and 220 unicast their signals to UE 110 over respective direct UE-to-UE links.

As the unicasted signals from UEs 210 and 220 are power-controlled, they are likely to be received in UE 110 at a lower power level than the broadcasted signal from UE 130, which is transmitted from UE 130 at a maximum allowed direct UE-to-UE power. Before providing the set and the measured RSRP values from respective UEs in the set to base station 140 for selection of the new relay UE, UE 110 is configured to adjust the measured RSRP values concerning unicasted signals, to make them more comparable to the RSRP value concerning broadcasted signals. This provides the technical benefit, that better choices may be made concerning the relay UE, leading to more dependable direct UE-to-UE links.

The adjusted unicast-signal RSRP values may be provided to the network in a report of candidate relay UEs, that is, the set of possible relay UEs, together with the measured RSRP values of broadcasted signals, to enable the network to meaningfully use the signal-strength values in selecting a relay UE from among candidate relay UEs, that is, from the set. The report is provided from the remote UE to the network. The selection of the relay UE may also depend on factors other than the signal-strength values, such as RSRPs and adjusted RSRPs. Such reporting may be used for relay reselection in the case of indirect-to-indirect path switch with layer-2 UE-to-network relay, and relay selection and reselection in the cases of direct-to-indirect and indirect-to-indirect path switches with UE-to-UE relay as well. A UE-to-UE relay may comprise using a relay UE by the remote UE to communicate with a further UE, rather than the network. In this case, the report is from the remote UE to the further UE to trigger the further UE to perform relay selection or reselection.

A first example of the adjusting of the unicast-signal RSRPs is based on transmit power headroom of the remote UE. In detail, the measured RSRP value from a unicasting candidate relay UE is compensated with transmit power headroom of the remote UE itself towards the candidate relay UE. For example, the transmit power headroom may be the difference of the maximum allowed UE-to-UE link transmission power and the currently used UE-to-UE link transmission power of the remote UE, such as UE 110, to transmit to the candidate relay UE on the direct UE-to-UE link:

$$RSRP reported = measured RSRP + ( Maximum TX power - Actual TX power ) .$$

This adjustment relies on the fact that the power control mechanism on the unicast link works in both directions, wherefore the transmit power headroom available in the remote UE, such as UE 110 in FIG. 2, contains information on the pathloss on the direct UE-to-UE link.

If the maximum transmission power for direct UE-to-UE links of the candidate relay UE is similar to the maximum transmission power of the remote UE, this adjustment yields a value that is similar to the case if transmission happened at maximum power from the candidate relay UE. This would make the RSRP directly well comparable to a RSRP of a broadcasted signal.

Yet further, base station 140 may be aware of the maximum transmission powers of the candidate relay UEs in set 201, which enables the base station to further adjust the reported RSRP values to account for different maximum direct UE-to-UE transmit powers in e.g. UEs 210 and 110. For example, if the maximum transmission power of the candidate UE is higher than that of the remote UE, then the base station may increment the reported RSRP value with the difference in maximum transmit powers between the UEs, and vice versa.

A second example of the adjusting of the unicast-signal RSRPs is based on using a measured pathloss on the unicast direct UE-to-UE link between the candidate relay UE and the remote UE. The measured RSRP value is, in the second example, compensated with the pathloss measured at the remote UE, such as UE 110 in FIG. 2:

$$RSRP reported = measured RSRP + pathloss .$$

Here the pathloss takes a negative value, or alternatively the pathloss can be replaced with maximum direct UE-to-UE transmit power of the reporting, remote UE-pathloss to obtain a positive value. The pathloss parameter may be obtained from the power control mechanism in use on the unicast direct UE-to-UE link, for example. These alternatives of the second example may be applied, for example, in case all candidate relay UEs in the set transmit to the remote UE using unicast. In a further alternative of the second example, the pathloss can be replaced with (maximum pathloss-measured pathloss) where the maximum pathloss corresponds to the use of a maximum transmission power from the remote UE towards the respective candidate relay UE. This further alternative may be applied for the case that candidate relay UEs in the set may transmit to the remote UE using unicast or broadcast.

As was the case for the first example, the base station may adjust for differing maximum transmit powers between the candidate relay UE(s) and the remote UE which sends the report.

A third example of the adjusting of the unicast-signal RSRPs is based on using a hysteresis parameter that is used to evaluate the radio quality on the direct UE-to-UE radio link between the reporting, remote UE and the candidate relay UE. In 3GPP network contexts, this parameter may be known as a sl-HystMin parameter. This option makes unicast RSRPs from different relay UE candidates and broadcast RSRPs from other relay UE candidates more comparable to each other.

In practice, the measured unicast RSRP value is compensated with the hysteresis that is used to evaluate the radio quality

$$RSRP reported = measured SL - RSRP + hysteresis\_parameter .$$

The hysteresis parameter, such as sl-HystMin, for example, may be advertised in the serving cell of the remote UE. The hysteresis parameter defines a margin to be applied to a minimum signal level limit when deciding whether to camp on a cell, or to initiate a direct UE-to-UE connection. The hysteresis parameter avoids a situation where a newly initiated connection would need to be reconfigured very soon after the initiation.

A benefit of each of the three examples presented above is, that they do not require inputs from the transmitting candidate relay UE. In some embodiments, the candidate relay UEs may be configured to indicate to the remote UE at least one power control related parameter, such as their transmit power used to transmit the signal to the remote UE, their maximum transmit power and/or a pathloss toward the remote UE when broadcasting or unicasting a signal to the remote UE(s) and signal strength measurement of the signal is expected. This allows the remote UE to compensate more accurately for at least unicasted signals from the candidate relay UE(s).

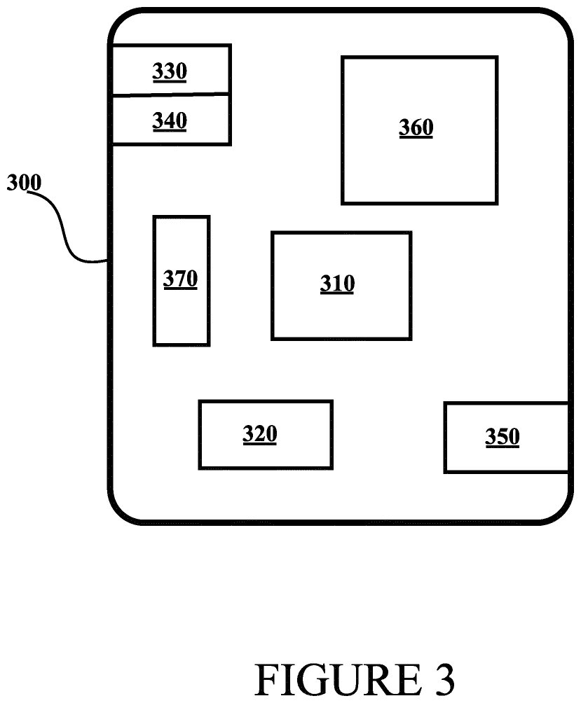

FIG. 3 illustrates an example apparatus capable of supporting at least some embodiments. Illustrated is device 300, which may comprise, for example, a UE such as UE 110 of FIG. 1 or FIG. 2, or, in applicable parts, a base station. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. When processor 310 comprises more than one processor, device 300 may be a distributed device wherein processing of tasks takes place in more than one physical unit. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as measuring, obtaining, including, adjusting and sending. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as user equipment or base station, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Memory 320 may be non-transitory. The term “non-transitory”, as used herein, is a limitation of the medium itself (that is, tangible, not a signal) as opposed to a limitation on data storage persistency (for example, RAM vs. ROM).

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

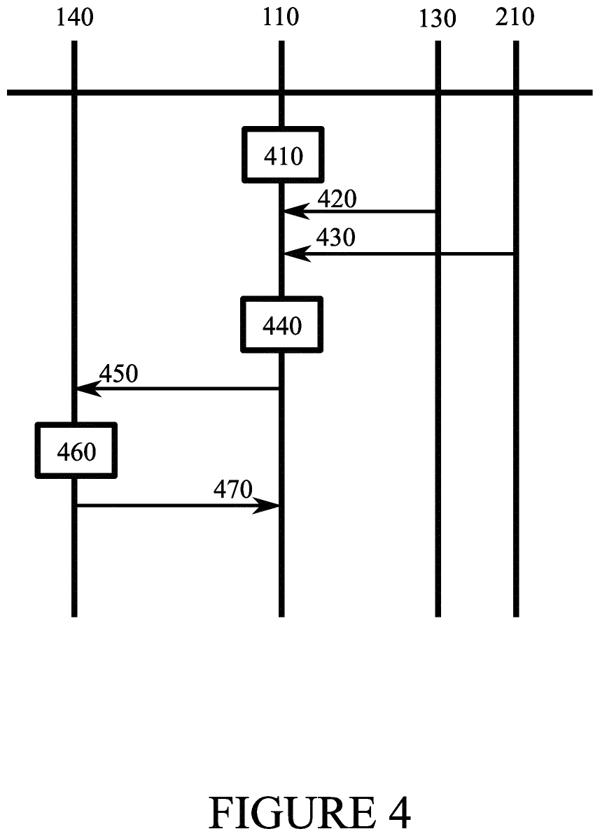

FIG. 4 illustrates signalling in accordance with at least some embodiments. On the vertical axes are disposed, from the left, base station 140, remote UE 110 and candidate relay UEs 130 and 210, of FIG. 2. Time advances from the top toward the bottom.

In phase 410, remote UE 110 has a direct UE-to-UE link with a relay UE, which is not illustrated in FIG. 4. Via the direct UE-to-UE link to the relay UE, remote UE 110 may access the Internet, implying a UE-to-Network relay for example, or information in a further UE which also has a direct UE-to-UE with the relay UE, implying a UE-to-UE relay for example.

To facilitate path switching and selection of a new relay UE, UE 110 measures RSRPs of signals from candidate relay UEs 130, 210, phases 420 and 430, respectively. Candidate relay UE 130 broadcasts its signal of phase 420 at a maximum allowed direct UE-to-UE transmit power, while candidate relay UE 210 unicasts its signal of phase 430, using power control with remote UE 110.

In phase 440, remote UE 110 adjusts the reference signal received power measurement of the signal of phase 430, using, for example, one of the three methods described herein above (based on power headroom, pathloss or hysteresis parameter) to perform this adjusting.

In phase 450, remote UE 110 provides a report to base station 140, or the further UE, comprising UE identifiers, the broadcast received signal power value and the adjusted unicast received signal power values of candidate relay UEs 130 and 210, respectively, for the set of candidate relay UEs. In some embodiments, the remote UE provides, rather than the adjusted unicast received signal power value, the measured unicast received signal power value and at least one adjustment parameter, such as the headroom, the pathloss or the hysteresis parameter. Examples of adjustment parameters include the power headroom value, the pathloss, the hysteresis parameter, and candidate relay UE-provided max transmit power, and/or candidate relay UE-provided actual transmit power, if provided from the candidate relay UE to the remote UE.

In phase 460, base station 140, or the further UE, selects the new relay UE from among the set of candidate relay UEs, in this case either UE 130 or UE 210. This selecting is based at least in part on the reported received signal power values of phase 450. The selecting may be further based on factors other than the reported signal power values. As described herein above, in some embodiments the base station is further configured to adjust the adjusted received power values based on maximum transmit powers of UEs that the base station knows. In some embodiments the base station is configured to perform the adjustment of received power values based on the at least one adjustment parameter provided to the base station by remote UE.

In phase 470, base station 140, or the further UE, informs remote UE 110 of the decision concerning which one of the candidate relay UEs has been chosen as the new relay UE.

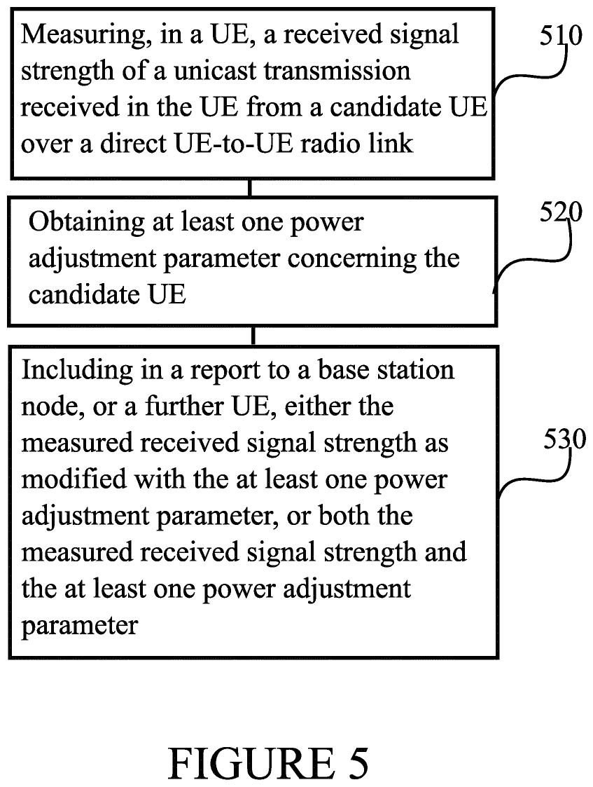

FIG. 5 is a flow graph of a method in accordance with at least some embodiments. The phases of the illustrated method may be performed in remote UE 110, for example, or in a control device configured to control the functioning thereof, when installed therein.

Phase 510 comprises measuring, in an user equipment, a received signal strength of a unicast transmission received in the user equipment from a candidate user equipment, UE, over a direct UE-to-UE radio link. Phase 520 comprises obtaining at least one power adjustment parameter concerning the candidate UE. Finally, phase 530 comprises including in a report to a base station node, or to a further user equipment, UE, either the measured received signal strength as modified with the at least one power adjustment parameter, or both the measured received signal strength and the at least one power adjustment parameter.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in operating wireless communication networks.

1. A user equipment comprising at least one processing core and at least one memory storing instructions that, when executed by the at least one processing core, cause the user equipment at least to:
measure a received signal strength of a unicast transmission received in the user equipment from another user equipment, UE, over a direct UE-to-UE radio link;
obtain at least one power adjustment parameter concerning the other UE, and
include in a report to a base station node, or a further user equipment, UE, either:
the measured received signal strength as modified with the at least one power adjustment parameter, or
both the measured received signal strength and the at least one power adjustment parameter.

2. The user equipment according to claim 1, wherein the at least one power adjustment parameter concerning the other UE comprises one or more of the following: a power headroom value indicating by how much the other UE is capable of increasing its transmit power without exceeding a maximum transmit power, a pathloss value indicating by how much the direct UE-to-UE radio link attenuates signals as they traverse the direct UE-to-UE radio link, and a hysteresis value that is used to evaluate radio link quality of the direct UE-to-UE radio link.

3. The user equipment according to claim 1 or 2, further configured to include in the report a second measured signal strength, of a broadcast transmission received in the apparatus from a second other UE, over a second direct UE-to-UE radio link, the user equipment not being configured to adjust the second measured signal strength to account for power control before including it in the report.

4. The user equipment according to any of claims 1-3, further configured to include in the report either a third measured signal strength, of a unicast transmission received in the apparatus from a third other UE, over a third direct UE-to-UE radio link, as modified with a at least one power adjustment parameter concerning the third other UE, or the third measured signal strength and the power adjustment parameter concerning the third other UE.

5. The user equipment according to any of claims 1-4, wherein the report is a sidelink measurement report in a fifth generation cellular communication system.

6. The user equipment according to any of claims 1-5, wherein the report is a measurement report, and wherein the user equipment is configured to send the measurement report to the base station node, or to the further UE, as part of the process to switch an indirect path between the user equipment and the base station node or the further UE, wherein the other UE is a relay candidate in the report.

7. The user equipment according to claim 6, wherein the user equipment is configured to send the report to the base station directly or via a current relay UE such that the user equipment does not have a radio connection to the base station at the moment the user equipment sends the report.

8. The user equipment according to claim 6, wherein the user equipment is configured to send the report to the further UE directly or via a current relay UE such that the apparatus does not have a radio connection to the further UE at the moment the apparatus sends the report.

9. A method comprising:
measuring, in a user equipment, a received signal strength of a unicast transmission received in the user equipment from another user equipment, UE, over a direct UE-to-UE radio link;
obtaining at least one power adjustment parameter concerning the other UE, and
including in a report to a base station node, or to a further UE, either:
the measured received signal strength as modified with the at least one power adjustment parameter, or
both the at least one measured received signal strength and the power adjustment parameter.

10. The method according to claim 9, wherein the at least one power adjustment parameter concerning the other UE comprises one or more of the following: a power headroom value indicating by how much the other UE is capable of increasing its transmit power without exceeding a maximum transmit power, a pathloss value indicating by how much the direct UE-to-UE radio link attenuates signals as they traverse the direct UE-to-UE radio link, and a hysteresis value that is used to evaluate radio link quality of the direct UE-to-UE radio link.

11. The method according to claim 9 or 10, further comprising including in the report a second measured signal strength, of a broadcast transmission received in the apparatus from a second other UE, over a second direct UE-to-UE radio link, the method not comprising adjusting the second measured signal strength to account for power control before including it in the report.

12. The method according to any of claims 9-11, further comprising including in the report either a third measured signal strength, of a unicast transmission received in the apparatus from a third other UE, over a third direct UE-to-UE radio link, as modified with a at least one power adjustment parameter concerning the third other UE, or the third measured signal strength and the power adjustment parameter concerning the third other UE.

13. The method according to any of claims 9-12, wherein the report is a sidelink measurement report in a fifth generation cellular communication system.

14. The method according to any of claims 9-13, wherein method comprises sending the report to the base station node or to the further UE via a current relay UE as part of a path switch process, wherein the UE is a relay candidate in the report.

15. A user equipment comprising:
means for measuring, in the user equipment, a received signal strength of a unicast transmission received in the user equipment from another user equipment, UE, over a direct UE-to-UE radio link;
means for obtaining at least one power adjustment parameter concerning the other UE, and
means for including in a report to a base station node or to a further UE either:
the measured received signal strength as modified with the at least one power adjustment parameter, or
both the measured received signal strength and the at least one power adjustment parameter.

16. A non-transitory computer readable medium having stored thereon a set of computer readable instructions that, when executed by at least one processor, cause a user equipment to at least:
measure a received signal strength of a unicast transmission received in the user equipment from another user equipment, UE, over a direct UE-to-UE radio link;
obtain at least one power adjustment parameter concerning the other UE, and
include in a report to a base station node or to a further UE either:
the measured received signal strength as modified with the at least one power adjustment parameter, or
both the measured received signal strength and the at least one power adjustment parameter.
